(19) United States
(12) Patent Application Publication
(10) Pub. No.: US 2008/0137499 A1
(43) Pub. Date: Jun. 12, 2008

(54) Optical disk apparatus and focusing method

(75) Inventor: Motoyuki Suzuki, Yokohama (JP)

Correspondence Address: MCDERMOTT WILL & EMERY LLP, 600 13TH STREET, N.W., WASHINGTON, DC, 20005-3096, US

(73) Assignee: HITACHI, LTD.

(21) Appl. No.: 11/987,710

(22) Filed: Dec. 4, 2007

(30) Foreign Application Priority Data
Dec. 7, 2006 (JP) 2006-330111

(51) Int. Cl. G11B 5/58

(52) U.S. Cl. 369/53.15

(57) ABSTRACT

An optical disk apparatus carries out focusing operation at a position shifted by a very small distance from the surface of a disk or from the recording surface of the disk in such a condition that the disk is stopped or is rotating at a speed sufficiently lower than a normal operational speed for the first focusing operation, after that, the disk is rotated at the normal rotational speed and a focus deviation amount is stored, and then focusing operation on an information recording surface is performed while applying the stored focus deviation component to a focus moving means.

### CLAIM OF PRIORITY

The present application claims priority from Japanese applications JP-2006-330111 filed on Dec. 7, 2006 the content of which is hereby incorporated by reference into this application.

### BACKGROUND OF THE INVENTION

The present invention relates to an optical disk apparatus and a focusing method.

One of background arts in the present technical field is disclosed in, for example, JP-A-07-65382. The Publication states “A value for the focus deviation of an optical disk 5 is found from an output of a focusing detector 10 and then stored in a memory circuit 25. the moving speed of a objective lens 4 is changed according to the focus deviation amount of the focus deviation memory circuit 25 upon refocusing operation to delay a relative speed of a light beam and the optical disk 5 and to obtain stable focusing operation”.

### SUMMARY OF THE INVENTION

Focusing operation in the prior art optical disk apparatus will be briefly explained.

The controlled focusing operation is carried out by rotating a recording medium (which will be referred to as the optical disk, hereinafter) at a predetermined rotational speed under control of a motor, converging, projecting a light beam emitted from a light source such as a semiconductor laser, and moving the objective lens.

When the focusing position of the light beam is moved to cause the light beam to pass over a recording surface of the disk, a focus error signal of an S curve shape is obtained. A range of detection of the S-shaped focus error signal is as narrow as several um. For this reason, in order to obtain stable focusing operation by decreasing an overshoot in the focusing operation, it is desirable to decrease the moving speed of the objective lens.

To this end, there is disclosed in JP-A-07-65382 a method of storing focus deviation amount as a movement in the vertical direction of the optical disk in the recording surface of the optical disk and applying the movement to a focus moving means upon refocusing operation in such a manner that a relative speed of the light beam to the optical disk is not influenced by the focus deviation.

As a result, the relative speed of the light beam to the optical disk upon the focusing operation can be reduced, thus enabling stable focusing control.

With the aforementioned arrangement, however, since the relative speed of the light beam to the optical disk is influenced by the focus deviation upon the first focusing operation before the focus deviation is stored, stable focusing control cannot be attained.

It is an object of the present invention to provide an optical disk apparatus which can attain stable focusing operation even upon the first focusing operation and also a focusing method.

The above object can be attained, as an example, by performing focusing operation in such a condition that a disk is stopped or the disk is rotating at a low speed for the first focusing operation.

In accordance with an aspect of the present invention, there can be provided an optical disk apparatus which performs stable focusing operation even upon the first focusing operation and also a focusing method.

Other objects, features and advantages of the invention will become apparent from the following description of the embodiments of the invention taken in conjunction with accompanying drawings.

### BRIEF DESCRIPTION OF THE DRAWINGS

FIG. 1 is a block diagram of a focusing device in a first embodiment:

FIG. 2 shows a waveform of a focus error signal in the first embodiment;

FIG. 3 shows waveforms of signals appearing in the first embodiment for explaining focusing operation;

FIG. 4 shows a flow chart of the focusing operation in the first embodiment;

FIG. 5 shows a block diagram of a focusing device in a second embodiment:

FIG. 6 shows a waveform of a focus error signal in the second embodiment;

FIG. 7 shows waveforms of signals appearing in the second embodiment for explaining focusing operation; and

FIG. 8 shows a flow chart of the focusing operation in the second embodiment.

### DETAILED DESCRIPTION OF THE INVENTION

The present invention will be explained as to embodiments of the invention with reference to the accompanying drawings.

In the following embodiment, it is assumed that focusing operation is performed in front of a disk surface or recording surface in such a condition that a disk is not rotated yet. However, the disk may be rotated in such conditions that the disk is rotated at a speed sufficiently lower than a normal rotational speed and is not influenced by focus deviation.

### Embodiment 1

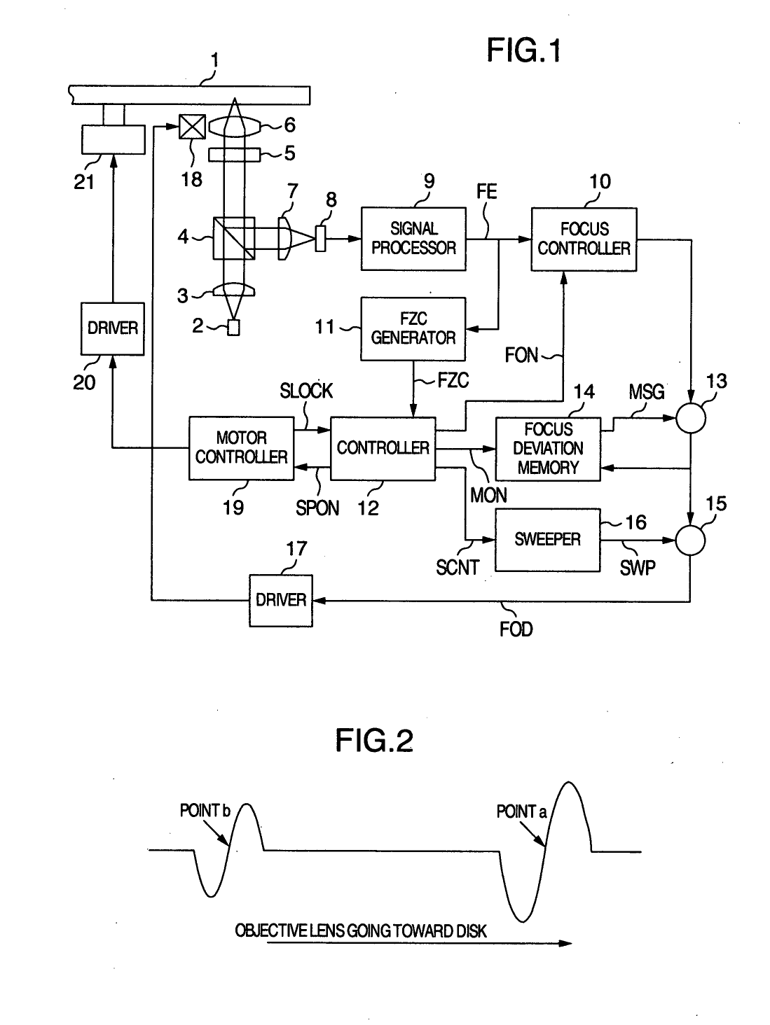

FIG. 1 shows an arrangement of an optical disk apparatus in accordance with a first embodiment.

In FIG. 1, a light beam emitted from a laser 2 is passed through a collimating lens 3 to form collimated light, and then passed through a beam splitter 4, a ¼ wavelength plate 5, and an objective lens 6 to be focused on a disk 1. Light reflected by the disk 1 is again passed through the objective lens 6 to form collimated light, passed through the ¼ wavelength plate 5, the beam splitter 4, and a cylindrical lens 7, and then directed into a light detector 8 where the incident light is converted to an electric signal.

An output of the light detector 8 is applied to a signal processor 9 which in turn generates a focus error signal FE indicative of a offset in the focus of the light beam focused on the disk 1. The focus error signal FE is applied to a focus controller 10 to be subjected to phase compensation for stable operation of a focus control system.

The focus error signal FE is also applied to an FZC (Focus Zero Cross) generator 11, which in turn compares the signal FE with a predetermined threshold Vth and outputs an FZC signal.

A controller 12 determines timing for focus control to be turned ON on the basis of the FZC signal, and outputs an FON signal to the focus controller 10. The focus controller 10 controls an output to an adder 13 according to the FON signal to turn ON/OFF the focus control.

The adder 13 adds an output of the focus controller 10 and an output of a focus deviation memory 14, and outputs an added result to an adder 15. A sweeper 16 outputs a sweep signal SWP to the adder 15 to drive an actuator 18 in a disk surface direction under control of a sweep control signal SCNT received from the controller 12. The output of the focus controller 10 is applied to the driver 17 via the adders 13 and 15 to drive the actuator 18. The objective lens 6 is arranged so as to be operated together with the actuator 18 as a single unit. That is, the actuator 18 is driven in a direction vertical to the disk surface for the focus control.

FIG. 2 shows a waveform of the focus error signal FE when the objective lens 6 is moved close to the disk 1 from a position sufficiently away from the disk. At a time point that the objective lens 6 first passes through a position b where the light beam is focused on the disk surface, a focus error signal called an S-shaped signal is output from the signal processor. At a time point that the objective lens 6 is further moved closer to the disk 1 and passes through at such a position a where the beam is focused on the information recording/reproducing surface, the S-shaped focus error signal is output from the signal processor.

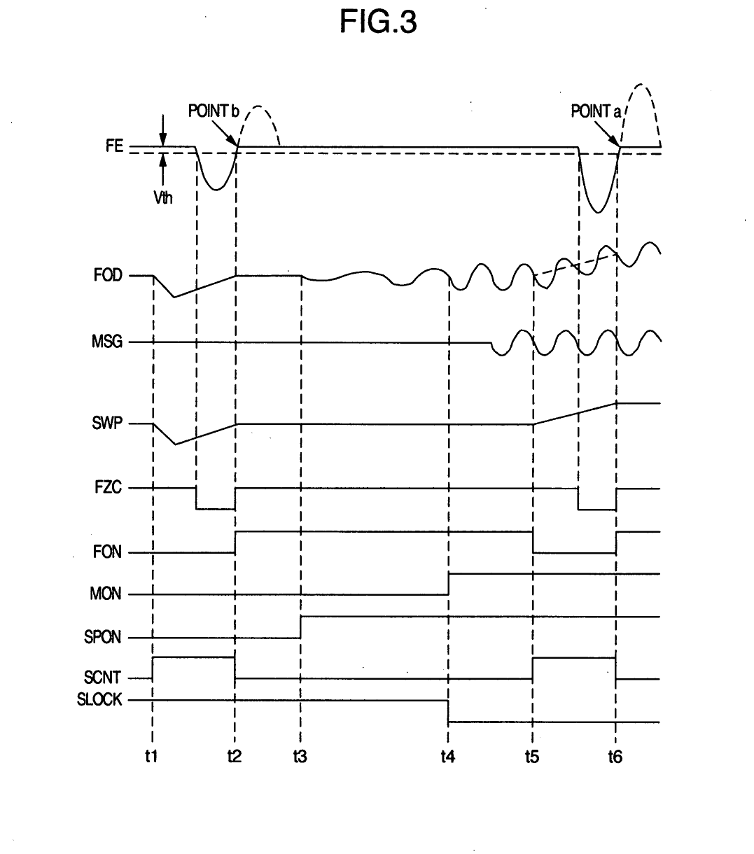

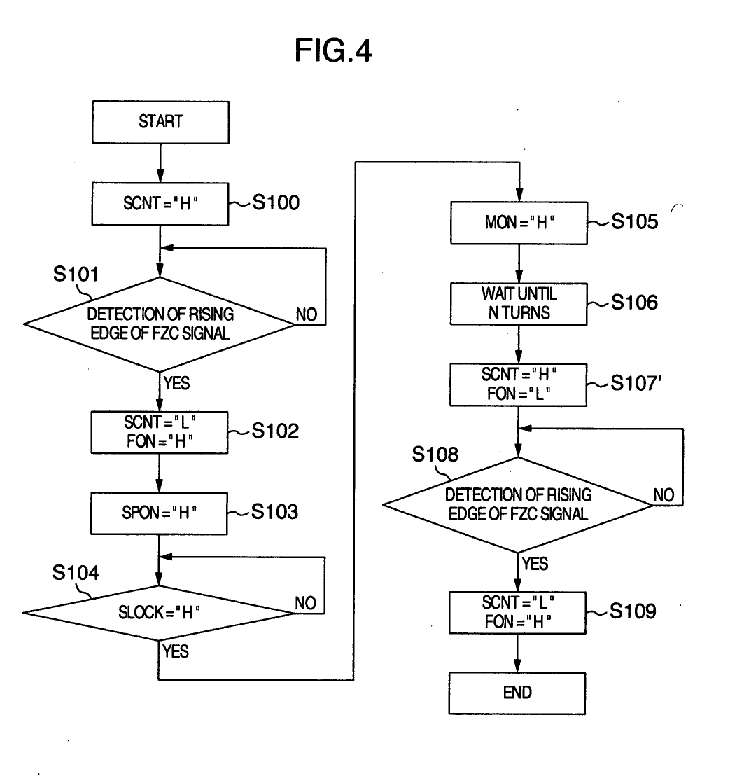

Explanation will next be made as to focusing operation by referring to FIGS. 3 and 4.

In the focusing operation, it is assumed that the sweep control signal SCNT output from the controller 12 to the sweeper 16 has first a high level of “H” (time t1, step S100). As a result, the sweeper 16 outputs such a sweep signal SWP as to move the objective lens 6 to a position sufficiently away from the disk surface and then to move the lens close to the disk surface, to the adder 15. The driver 17 drives the actuator 18 toward the disk surface according to the sweep signal SWP. When the objective lens 6 reaches a position in the vicinity of the focused position or point b on the disk surface, the S-shaped focus error signal is output from the signal processor. An FZC generator 11 compares the focus error signal with the predetermined threshold Vth and outputs the FZC signal to the controller 12. The controller 12 determines at a rising edge of the FZC signal that the objective lens 6 reached the focused position or point b on the disk surface (time t2, step S101), and sets the sweep control signal SCNT to have a low level of “L” and a focus ON signal FON to have a high level of “H” (time t2, step S102). This causes the sweep signal SWP to be stopped, the focus control to be started, and the focusing operation on the disk surface to be carried out. When a spindle ON signal SPON issued to a motor controller 19 is set to have a high level of “H”, the motor controller 19 outputs a control signal to a driver 20 to rotate a motor 21 at a predetermined rotational speed and to turn the disk 1 (time t3, step S103). The motor controller 19 outputs a SLOCK signal indicative of the rotational state of the disk 1, to the controller 12. At a time point that the rotational speed of the disk 1 reaches a predetermined level, the SLOCK signal is set to have a high level of “H” (time t4). When confirming that the level of the SLOCK signal was changed to “H” (step S104), the controller 12 set the level of a MON signal to be output to the focus deviation memory 14 at “H”, thus starting recording a focus deviation component (step S105). The focus deviation memory 14 stores therein the focus deviation component from the output of the adder 13, and again adds the stored focus deviation component to the adder 13, thus forming a so-called repetitive control system. At a time point that the recording of the focus deviation component was started and then recording operation was carried out during a predetermined number N of turns, the controller 12 sets the sweep control signal SCNT to be output to the sweeper 16 therefrom to have a high level of “H” and also sets the focus ON signal FON to have a low level of “L” (time t5, step S106). As a result, the focus control is turned OFF and simultaneously the sweep signal SWP is output from the sweeper 16 to move the objective lens 6 closer to the recording surface of the disk 1. The sweep signal and the output of the focus deviation memory 14 are added together at the adders 13 and 15, and the added signal is sent to the driver 17 to generate such a signal as to drive the actuator 18. As a result, the objective lens 6 is driven toward the recording surface according to the sweep signal SWP issued from the sweeper 16 while substantially following up the focus deviation amount. When the objective lens 6 reaches a position in the vicinity of the focused position or point a on the recording surface, the S-shaped focus error signal is output from the signal processor. The FZC generator 11 compares the focus error signal with the predetermined threshold Vth and outputs the FZC signal to the controller 12. The controller 12 determines at a rising edge of the FZC signal that the objective lens 6 reached the focused point a on the recording surface (time t6, step S108), and sets the sweep control signal SCNT to have a low level of “L” and the focus ON signal FON to have a high level of “H” (step S109). As a result, the sweep signal SWP is stopped and simultaneously the focus control is started to carry out the focusing operation on the recording surface.

When the first focusing operation is carried out in such a condition that the disk is not rotated yet or is rotated at a speed much lower than the predetermined rotational speed as in the embodiment 1, the relative speed between the light beam and the optical disk can be made small and stable focusing operation can be attained advantageously. During recording an amount of focus deviation, the light beam is focused on the disk surface not on the recording surface. Thus information on the recording surface is not destroyed by this operation.

### Embodiment 2

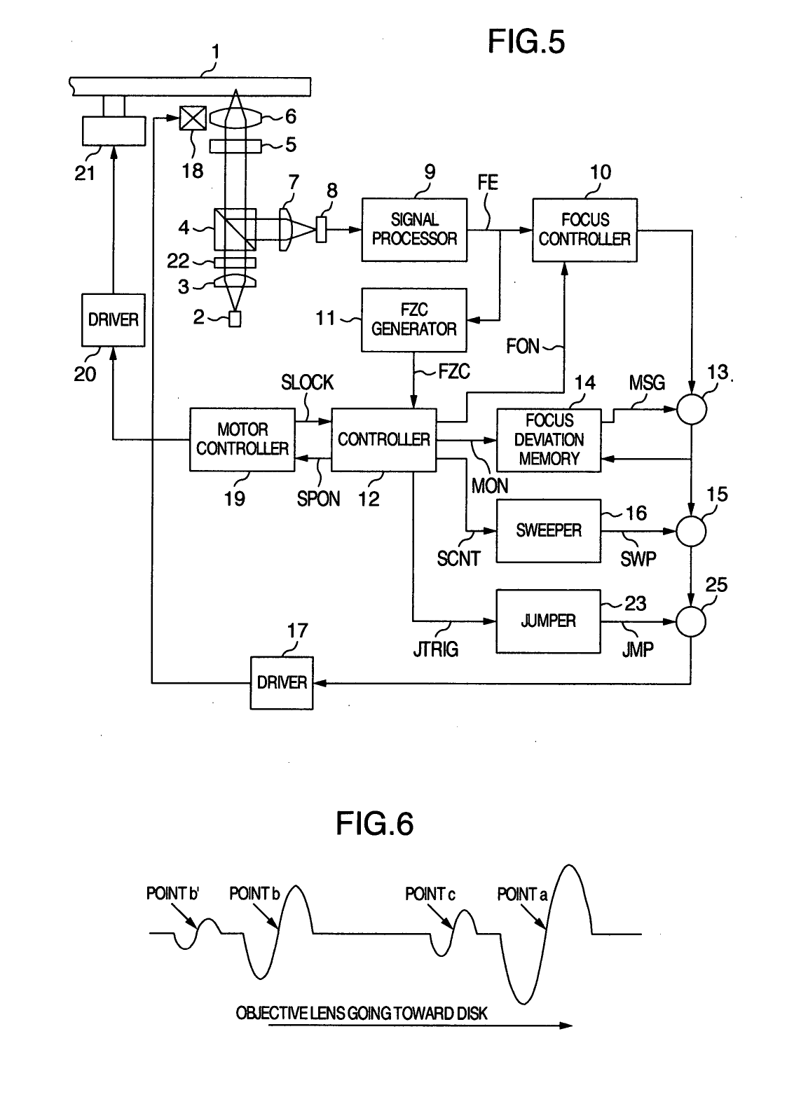

Next, the second embodiment of the present invention will be explained by referring to FIGS. 5 to 8.

In FIG. 5, constituent elements having the same functions as those in FIG. 1 are denoted by the same reference numerals or symbols. Reference numeral 22 denotes a diffraction grating which divides a light beam issued from the laser 2 into first-order and zero-order light beams. The zero-order light beam is used mainly to detect record/reproduce signals, and the first-order light beam is used together with the zero-order light beam to detect a focus error. A method of detecting a focus error using the first-order light beam and the zero-order light beam is known as a differential astigmatism method. A jumper 23 outputs a jump signal JMP to cause the actuator 18 to be accelerated or decelerated toward the disk surface according to a jump trigger signal JTRIG received from the controller 12

FIG. 6 shows a waveform of the focus error signal FE when the objective lens 6 is moved close to the disk 1 from a position much spaced from the disk 1 in the differential astigmatism method. At a time point that the objective lens 6 first passes through a point b′ before the light beam is focused on the disk surface, a focus error signal of an S curve shape is output.

At a time point that the objective lens 6 further passes through a point b at which the light beam is focused on the disk surface the objective lens 6 is moved toward the disk 1, the S-shaped focus error signal is output. At a time point that the objective lens 6 passed through the point a′ before the light beam is focused on the recording surface as the objective lens 6 is moved toward the disk 1, the S-shaped focus error signal is output. At a time point that the objective lens 6 passes through the point a at which the light beam is focused on the recording surface as the objective lens 6 is moved toward the disk 1, the S-shaped focus error signal is output. Accordingly, in the differential astigmatism method, the S-shaped focus error signal is detected four times at positions at which the light beam is focused on the disk surface and on the recording surface and at positions before the former positions as the objective lens 6 is moved closer to the disk 1 from a position sufficiently away from the disk 1.

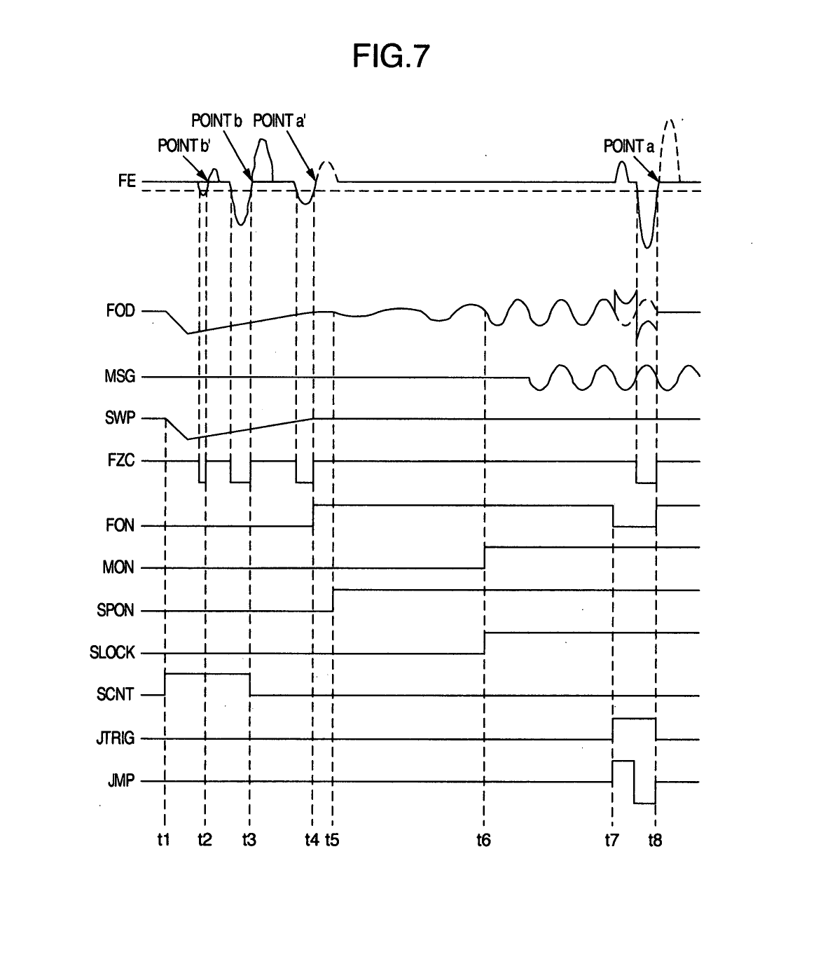

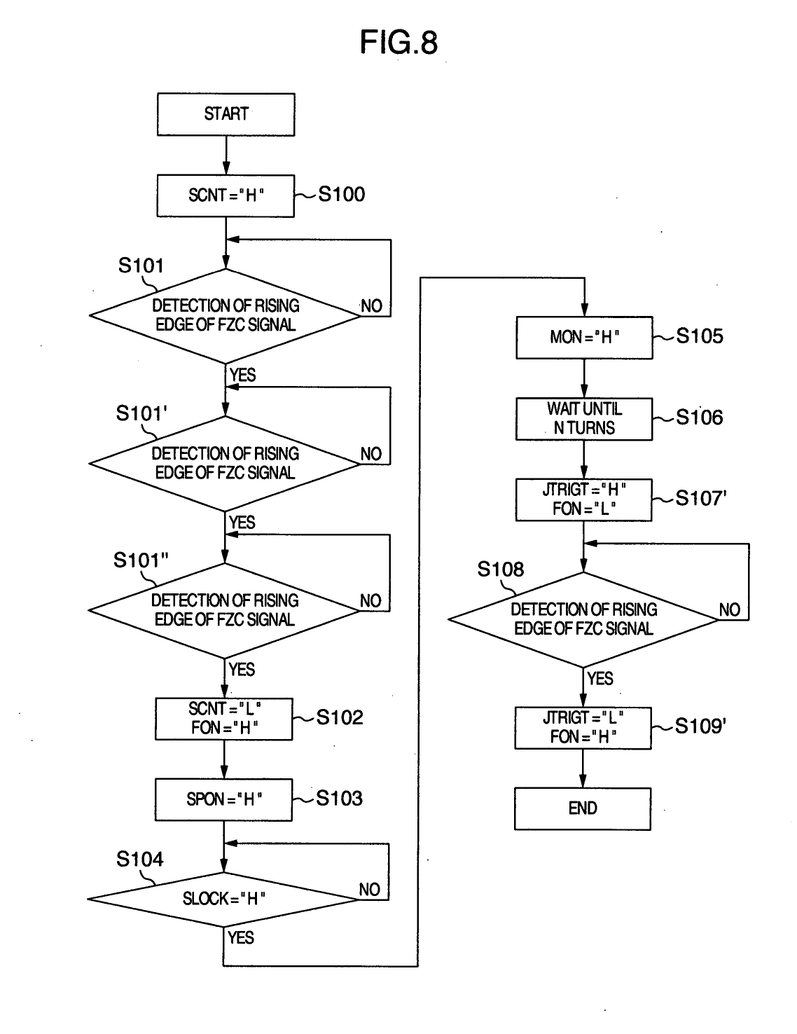

Explanation will next be made as to the focusing operation with reference to FIGS. 7 and 8. In the focusing operation, it is assumed that the sweep control signal SCNT output from the controller 12 to the sweeper 16 is first set to have a high level of “H” (time t1, step S100). This causes the sweeper 16 to output to the adder 15 the sweep signal SWP to move the objective lens 6 at a position sufficiently away from the disk surface and then to move it closer to the disk surface. The driver 17 drives the actuator 18 toward the disk surface according to the sweep signal SWP. When the objective lens 6 reaches a position in the vicinity of the focused point b′ where the light beam is focused on the disk surface, a first S-shaped focus error signal is output. The FZC generator 11 compares the focus error signal with the predetermined threshold Vth and output the FZC signal to the controller 12. The controller 12 determines at a rising edge of the FZC signal that the objective lens 6 reached a point b′(time t2, step S101). As the objective lens 6 is further moved closer to the disk 1, a second S-shaped focus error signal is output at a point in the vicinity of a point b at which the light beam is focused.

The controller 12 determines at a rising edge of the FZC signal that the objective lens 6 reached the point b (time t3, step S101′). When the objective lens 6 is moved closer to the disk 1, a third S-shaped focus error signal is output at a point in the vicinity of the point a′ before a point at which the light beam is focused on the recording surface. The controller 12 determines at a rising edge of the FZC signal that the objective lens 6 reached the point a′ (time t4, step S101″). The controller sets the sweep control signal SCNT to have a low level of “L” and the focus ON signal FON to have a high level of “H” (time t4, step S102). As a result, the sweep signal SWP is stopped, and simultaneously the focus control is started to perform the focusing operation at the point a′ before the recording surface. Next, when the spindle ON signal SPON output to the motor controller 19 is set to have a high level of “H”, a control signal is output from the motor controller 19 to the driver 20 to rotate the motor 21 at a predetermined rotational speed and to turn the disk 1 (time t5, step S103). The SLOCK signal indicative of a rotational state of the disk 1 is output from the motor controller 19 to the controller 12, so that the SLOCK signal has a high level of “H” when the rotational speed of the disk 1 reached a predetermined value (time t6). The controller 12 confirms that the SLOCK signal had a high level of “H” (step S104), sets the level of the MON signal to be output to the focus deviation memory 14 at a high level “H” to start recording the focus deviation component (step S105). The focus deviation memory 14 stores therein a focus deviation component from the output of the adder 13, and the stored focus deviation component is again sent to the adder 13, thus forming a so-called repetitive control system. At a time point that the recording operation was carried out by a predetermined number N of turns after the recording of the focus deviation component was started (step S106), the controller 12 sets the level of the jump trigger signal JTRIG to be output from the controller 12 to the jumper 23 at a high level “H” and also sets the level of the focus ON signal FON at a low level “L” (time t7, step S107′). As a result, the focus control is turned OFF and simultaneously, the jumper 23 outputs a jump signal JMP to cause the objective lens 6 to be moved toward the recording surface of the disk 1. The jump signal and the output of the focus deviation memory 14 are added together in the adders 13, 15, and 25 to form a signal. The formed signal is sent to the driver 17 to drive the actuator 18. As a result, the objective lens 6 is driven toward the recording surface according to the jump signal JMP issued from the jumper 23 while substantially following up the focus deviation amount. When the objective lens 6 reaches a point in the vicinity of the position a where the light beam is focused on the recording surface, a S-shaped focus error signal is output. The FZC generator 11 compares the focus error signal with the predetermined threshold Vth and outputs the FZC signal to the controller 12. The controller 12 determines at a rising edge of the FZC signal that the objective lens 6 reached the beam focused point a on the recording surface (time t8, step S108), and sets the jump trigger signal JTRIG to have a low level “L” and the focus ON signal FON to have a high level “H” (step S109′). As a result, the jump signal JMP is stopped and simultaneously the focus control is started, thus attaining the focusing operation on the recording surface.

When the first focusing operation is carried out in such a condition that the disk is not rotated yet or is rotated at a speed sufficiently lower than a predetermined rotational speed as in the embodiment 2, the relative speed between the light beam and the optical disk can be made small and the stable focusing operation can be attained advantageously. When an a focus deviation level is recorded, the light beam is not focused on the recording surface by focusing the light beam at a position immediately before the recording surface. Thus information on the recording surface can advantageously be avoided from being destroyed. Since the focusing operation is made at a position away from the recording surface, the focus can advantageously be less influenced by a flaw or dust on the disk surface than when the focusing operation is made on the disk surface.

It should be further understood by those skilled in the art that although the foregoing description has been on embodiments of the invention, the invention is not limited thereto and various change and modifications may be made without departing from the spirit of the invention and the scope of the appended claims.

1. An optical disk apparatus in which an optical disk can be mounted comprising:
a laser for emitting light;
an objective lens for focusing the light from said laser on the disk;
an actuator for moving said objective lens;
focus error detecting means for detecting a focus error for the light focused by said objective lens and outputting a S-shaped focus error signal;
a spindle motor for rotating the optical disk;
memory means for a focus deviation amount when the optical disk is rotated by said spindle motor; and
control means for controlling said actuator to control the focusing operation,
wherein, said control means carries out the focusing operation at a S-shaped focus error signal detection position other than a recording surface of the optical disk when a rotational speed of the optical disk is zero or sufficiently low, and thereafter, increases the rotational speed of the optical disk storing the focus deviation amount, adds the stored focus deviation amount and controls said actuator.

2. An optical disk apparatus according to claim 1, wherein the S-shaped focus error signal detection position other than the recording surface of the optical disk is on the surface of the optical disk.

3. An optical disk apparatus according to claim 2, wherein said control means stores the focus deviation amount on the surface of the optical disk, said stored level is added, and controls said actuator in such a manner that said objective lens is gradually moved closer to the optical disk and the focusing operation is carried out on the recording surface.

4. An optical disk apparatus according to claim 1, wherein the S-shaped focus error signal detection position other than the recording surface of the optical disk is in the vicinity of the recording surface.

5. An optical disk apparatus according to claim 4, wherein said control means stores a focus deviation amount at the S-shaped focus error signal detection position in the vicinity of the recording surface, adds the stored amount, and controls said actuator in such a manner that said objective lens is jumped and moved toward the optical disk and the focusing operation is carried out on the recording surface.

6. A focusing method in an optical disk apparatus, said optical disk apparatus comprising:
means for irradiating an optical disk with a light beam;
rotational control means for rotating said optical disk;
focus error detecting means for detecting a focused state of the light beam to said optical disk;
focus moving means for moving an objective lens substantially in a vertical direction to a surface of said optical disk;
focus control means for controlling said focus moving means according to an output of said focus error detecting means;
focus deviation memory means for detecting a focus deviation amount of said optical disk according to the output of said focus error detecting means and storing the detected focus deviation amount;
sweep signal generating means for generating a sweep signal to cause said focus moving means to move the objective lens away from or toward said optical disk; and
focusing means detecting a focusing position on the basis of an output of said focus error detecting means and starting said focus control means,
said method comprising the steps of:
storing a focus deviation amount in said focus deviation memory means in a condition that the light beam is focused on the surface of the optical disk;
moving the objective lens onto an information recording/reproducing surface; and
carrying out focus operation on the basis of a signal corresponding to an addition of an output of said focus deviation memory means and the sweep signal.

7. A focusing method in the optical disk apparatus according to claim 6, wherein the focusing operation onto said disk surface is carried out when the rotation of the disk is stopped or at a speed sufficiently lower than a rotational speed in a record or reproduce mode.

8. A focusing method in the optical disk apparatus according to claim 6, wherein the focus deviation amount of said optical disk is stored by said focus deviation memory means setting the rotational speed of the optical disk same as in the record or reproduce mode after the light beam is focused on said disk surface.

9. A focusing method in an optical disk apparatus, said optical disk apparatus comprising:
means for irradiating an optical disk with a light beam;
rotational control means for rotating said optical disk;
focus error detecting means for detecting a focused state of the light beam to said optical disk and generating a S-shaped error signal;
focus moving means for moving the objective lens nearly in a vertical direction with respect to a surface of said optical disk;
focus control means for controlling said focus moving means according to an output of said focus error detecting means;
focus deviation memory means for detecting a focus deviation amount of said optical disk on the basis of the output of said focus error detecting means and storing the detected focus deviation level;
sweep signal generating means for generating a sweep signal to cause said focus moving means to move the objective lens away from or toward said optical disk;
focusing means for detecting a focusing position on the basis of the output of said focus error detecting means and starting said focus control means; and
jump signal generating means for driving said focus moving means and generating a signal to accelerate or decelerate the objective lens,
said method comprising the steps of:
detecting the S-shaped focus error signal at least at an information record/reproduce surface or in the vicinity of the information record/reproduce surface in said focus error detecting means;
focusing the light beam at an S-shaped focus error signal detection position in the vicinity of said record/reproduce surface;
storing a focus deviation amount in said focus deviation memory means; and
moving the objective lens onto the information record/reproduce surface and focusing the light beam on the basis of a signal corresponding to an addition of an output of said focus deviation memory means and the jump signal.

10. A focusing method in the optical disk apparatus according to claim 9, wherein the focusing operation at the S-shaped focus error signal detection position in the vicinity of said record/reproduce surface is carried out when the rotation of the disk is stopped or at a rotational speed sufficiently lower than a rotational speed in the record or reproduce mode.

11. A focusing method in the optical disk apparatus according to claim 9, wherein the focus deviation amount is stored by said focus deviation memory means setting a rotational speed same as in the record or reproduce mode of said optical disk after the focusing operation at the S-shaped focus error signal detection position in the vicinity of said record/reproduce surface.
